(19) United States
(12) Patent Application Publication
(10) Pub. No.: US 2021/0233479 A1
(43) Pub. Date: Jul. 29, 2021

(54) CONTROL DEVICE, DISPLAY DEVICE, AND CONTROL METHOD

(71) Applicant: SHARP KABUSHIKI KAISHA, Sakai City, Osaka (JP)

(72) Inventors: MAKOTO SHIOMI, Sakai City, Osaka (JP); NAOKO GOTO, Sakai City, Osaka (JP); NAOTO INOUE, Sakai City, Osaka (JP); AYA OKAMOTO, Sakai City, Osaka (JP); OSAMU TERANUMA, Sakai City, Osaka (JP); MASAO KURINO, Sakai City, Osaka (JP); YUKI KATSUMURA, Sakai City, Osaka (JP)

(21) Appl. No.: 16/972,239

(22) PCT Filed: May 31, 2019
(86) PCT No.: PCT/JP2019/021858

§ 371 Date: Dec. 4, 2020

(30) Foreign Application Priority Data
Jun. 15, 2018 (JP) 2018-114856

(51) Int. Cl. G09G 3/34; G09G 3/36

(52) U.S. Cl. CPC G09G 3/3426; G09G 3/36; G09G 2320/0686; G09G 2320/062; G09G 2330/021

(57) ABSTRACT

To provide a control device capable of reducing power consumption of a display device. A display controller is a control device of a display device including a display including a plurality of light sources to be independently controlled. In accordance with levels of unimportance or levels of importance each corresponding to one of display items displayed by one or more applications of the display device, the display controller controls brightness of a light source corresponding to a display region for the one display item. The light source is included in the light sources.

### TECHNICAL FIELD

A disclosure below relates to a control device to control how to display an image, a display device including the control device, and a control method for controlling how to display an image.

### BACKGROUND ART

Techniques to reduce power consumption of image display devices performing high-dynamic-range (HDR) rendering are disclosed in such related art documents as Patent Document 1. The invention disclosed in Patent Document 1 limits regions to be subjected to the HDR rendering to a specific region to reduce power consumption. The specific region is, for example, an image region on which a user desires the HDR rendering to be performed.

### CITATION LIST

### Patent Literature

[Patent Document 1] Japanese Unexamined Patent Application Publication No. 2017-045030 (published on Mar. 2, 2017)

### SUMMARY OF INVENTION

### Technical Problem

Unfortunately, Patent Document 1 fails to disclose a technique to reduce power consumption without deteriorating visibility in obtaining information.

An aspect of the present disclosure is intended to provide, for example, a control device capable of reducing power consumption, without compromising visibility in obtaining information displayed on a display device.

### Solution to Problem

In order to solve the above problem, a control device according to an aspect of the present disclosure is of a display device including a display including a plurality of light sources to be independently controlled. In accordance with levels of unimportance or levels of importance each corresponding to one of display items displayed by one or more applications of the display device, the control device controls brightness of a light source corresponding to a display region for the one display item. The light source is included in the light sources.

A control method according to an aspect of the present disclosure is for controlling a display device including a display including a plurality of light sources to be independently controlled. In accordance with levels of unimportance or levels of importance each corresponding to one of display items displayed by one or more applications of the display device, the control method includes controlling brightness of a light source corresponding to a display region for the one display item. The light source is included in the light sources.

### ADVANTAGEOUS EFFECTS OF INVENTION

A control device according to an aspect of the present disclosure can reduce power consumption, without compromising visibility in obtaining information displayed on a display device.

### BRIEF DESCRIPTION OF DRAWINGS

FIG. 1 is a block diagram illustrating a configuration of a display device according to a first embodiment.

FIG. 2 includes an illustration (a) for showing an example of image processing using a local dimming function, and a graph (b) showing a grayscale value, of liquid crystal data in the illustration (a), taken along line A-A.

FIG. 3 is a flowchart showing an operation of the display device according to the first embodiment.

FIG. 4 is a block diagram illustrating a configuration of a display device according to a second embodiment.

FIG. 5 is a block diagram illustrating specific configurations of a backlight-data generator and a liquid-crystal-data generator according to the second embodiment.

FIG. 6 is a flowchart showing an operation of the display device according to the second embodiment.

FIG. 7 is a graph showing backlight brightness with respect to input image brightness, liquid crystal transmittance, and output brightness of the display device according to the second embodiment.

FIG. 8 is a block diagram illustrating a configuration of a display device according to a third embodiment.

FIG. 9 is a block diagram illustrating configurations of a backlight-data generator, a liquid-crystal-data generator, and a brightness reduction processor according to the third embodiment.

FIG. 10 is a graph showing backlight brightness with respect to input image brightness, liquid crystal transmittance and output brightness of the display device according to the third embodiment.

FIG. 11 is a graph showing an example of a relationship between brightness of a pixel before processing and brightness of the pixel after processing performed by the brightness reduction processor included in the display device according to the third embodiment.

FIG. 12 is a block diagram illustrating other configurations, than those in FIG. 19, of the backlight-data generator, the liquid-crystal-data generator, and the brightness reduction processor according to the third embodiment.

FIG. 13 is a flowchart showing processing performed by the display device according to the third embodiment.

### DESCRIPTION OF EMBODIMENTS

### First Embodiment

A first embodiment of the present disclosure will be described below in detail.

### Configuration of Display Device 1

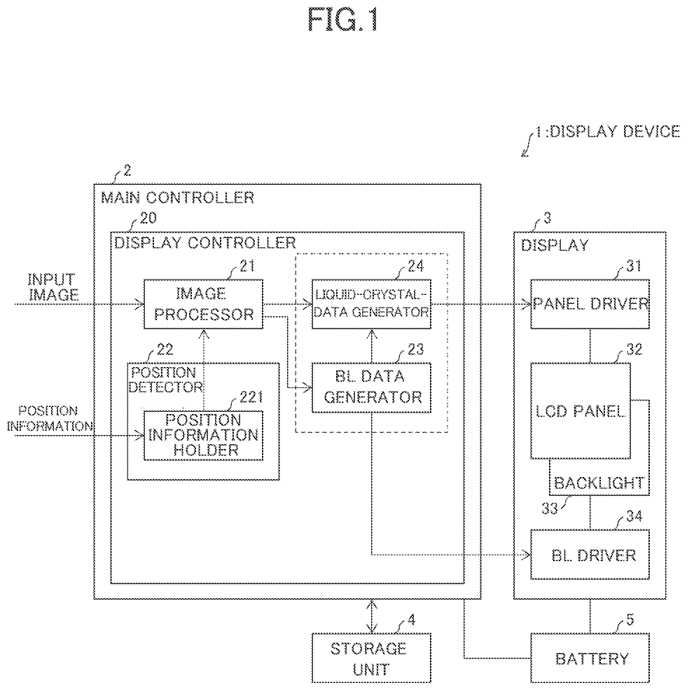

FIG. 1 is a block diagram illustrating a configuration of a display device 1 according to the first embodiment. As illustrated in FIG. 1, the display device 1 displays various kinds of input images. The display device 1 includes: a main controller 2; a display 3; a storage unit 4; and a battery 5. The display device 1 is, for example, a personal digital assistance.

The main controller 2 has overall control of the display device 1. The storage unit 4 stores such data as a program to be processed by the main controller 2. The battery 5 stores power to be supplied to units of the display device 1. That is, the units of the display device 1 are driven by the battery 5.

The display 3 displays an input image processed by a display controller 20 (a control device). In the first embodiment, the display 3 is a liquid crystal display (LCD). Specifically, the display 3 includes: a panel driver 31; an LCD panel 32; a backlight 33; and a backlight driver 34. Note that, in the drawings, the term “backlight” is also denoted as “BL.”

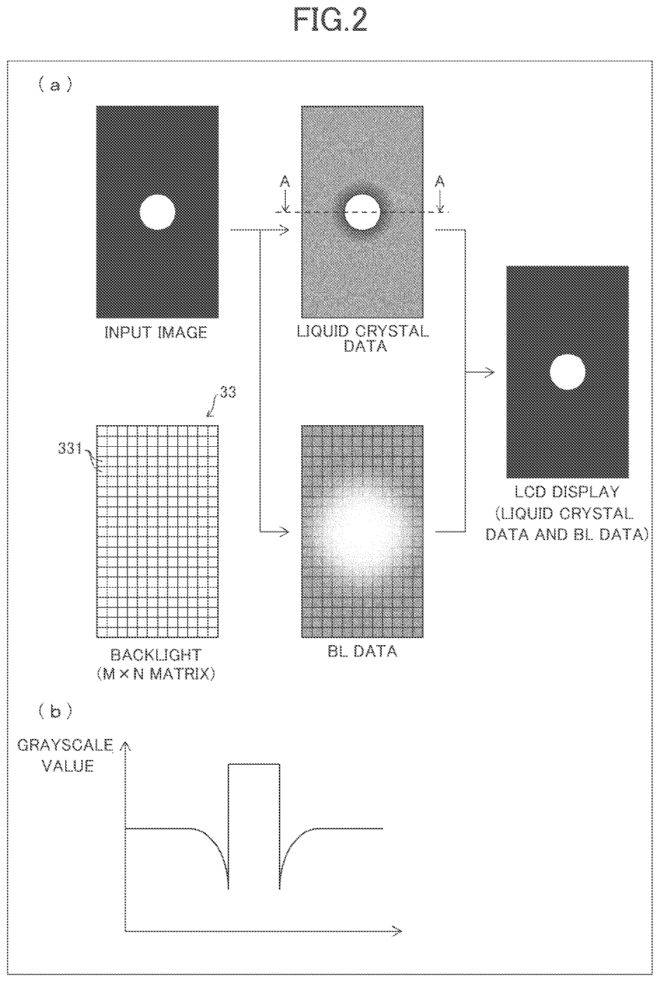

The panel driver 31 controls to drive the LCD panel 32 in accordance with liquid crystal data based on the input image processed by the display controller 20. The LCD panel 32 displays the processed input image. The backlight 33 includes a plurality of light sources 331 (see FIG. 2) to be independently controlled. The backlight driver 34 causes the backlight 33 to glow in accordance with backlight data based on the input image processed by the display controller 20.

The main controller 2 includes the display controller 20 to control the display 3. In accordance with levels of unimportance each corresponding to one of display items displayed by one or more applications installed in the display device 1, the display controller 20 controls brightness of a light source 331 corresponding to a display region for the one display item. Here, the light source 331 is included in the light sources 331. The level of unimportance indicates how unimportant the display item is. In the first embodiment, the display controller 20 obtains from an application run by the display device 1 a level-of-unimportance information item indicating a level of unimportance for each display item of the application, and controls brightness of a light source 331 in accordance with the level-of-unimportance information item. The level of unimportance may be represented by a number, a letter, or a sign.

A display region displaying an image more darkly than the input image is referred to as a dark region. In contrast, a display region displaying an image as bright as the input image is referred to as a bright region. The dark region usually appears darker than the bright region; however, the dark region does not necessarily have to be completely dark.

For example, when using a call application, the user does not basically need to have information displayed on the screen. Hence, on the call application, the level of unimportance may be set high for all the display items.

Moreover, when using a music playback application, the user hardly has to look at an operation button during the playback of the music. Moreover, even if the music playback application is capable of displaying music information or song lyrics, such information might not be important for the user. Hence, on the music playback application, the level of unimportance may be set high for all these display items.

Furthermore, when using a schedule management application, for example, the user does not have to always look at schedules in most cases except for a schedule relatively near the present time, or a schedule recently added or changed. Hence, on the schedule management application, the level of unimportance may be set high for any schedule that belongs to neither of such schedules.

Moreover, on an incoming e-mail message list of an e-mail application, for example, the user does not have to look at messages in most cases except for a message sent from a sender of the user's interest, or a newly arriving message. In addition, when using a word processing application, the user does not have to look at the screen in most cases except for a cursor and its proximity for texting and editing. Hence, on the word processing application, the level of unimportance may be set high for such an unimportance region to be looked at.

Moreover, the level of unimportance can be set not only for applications but also for images displayed by the system. For example, when two or more images are found to display notice information items by the system, the level of unimportance may be set higher for an older notice information item.

In the first embodiment, it is assumed that information to be displayed in a region having a high level of unimportance is not important for the user. On the basis of this assumption, the first embodiment involves decreasing brightness of such a region to reduce power consumption.

The display controller 20 performs display processing that involves causing a light source 331 of the back light 33 to glow less brightly than another light source 331 of the back light 33. Here, the light source 331 corresponds to a display region (an unimportant display region) displaying a display item the level of unimportance of which is a predetermined level or higher, and the other light source 331 corresponds to a region (a necessary display region) other than the unimportant display region.

### Local Dimming Function

In the first embodiment, image display processing is performed, using a local dimming function. In the local dimming function, the display region of the LCD 32 is divided into a matrix, and each of the light sources 331 of the backlight 33 is controlled to glow for a corresponding one of the divided sub-regions (namely, local areas, or blocks). Described here with reference to illustrations (a) and (b) in FIG. 2 is an example of image processing performed on the local dimming function. The illustration (a) in FIG. 2 shows an example of the image processing. The illustration (b) in FIG. 2 is a graph showing a grayscale value, in the illustration (a) of FIG. 2, taken along line A-A. In the illustration (b) of FIG. 2, the horizontal axis and the vertical axis respectively represent a position and a grayscale value on the line A-A.

In an input image in the illustration (a) of FIG. 2, a region outlined in white is higher in brightness than the rest of the region. Furthermore, the display region of the LCD panel 32 (i.e., the backlight 33 corresponding to the display region) is divided into the sub-regions (an m×n matrix). The illustration (a) of FIG. 2 shows that the backlight 33 is divided into m×n sub-regions. Each of the sub-regions includes one of the light sources 331. Note that each sub-region may include two or more of the light sources 331.

When the local dimming function is used to process an image as shown in the illustration (a) of FIG. 2, backlight data to control brightness of the backlight 33 is generated in accordance with a brightness value (or a pixel value) of the input image. Specifically, the input image is divided into regions each corresponding to one of the sub-regions. In accordance with a brightness value of the divided region, determined as the backlight data is a light-source brightness value of each light source 331 included in a corresponding one of the sub-regions of the backlight 33. In the first embodiment, the backlight data is generated by a backlight-data generator 23.

In accordance with the backlight data and the brightness values of the input image, liquid crystal data to control the LCD panel 32 is generated. Specifically, brightness distribution of the backlight 33 is calculated in accordance with the backlight data and a brightness spread function (i.e., a point spread function, or PSF) which is data representing how light spreads in values. Each of the brightness values (normalized values) of the input image is divided by a corresponding one of brightness values (normalized values) for brightness distribution of the backlight 33, thus determining an output value (a liquid crystal transmittance) for each pixel of the LCD panel 32. As data to indicate this output value, the liquid crystal data shown in the illustration (b) of FIG. 2 is generated. In the first embodiment, the liquid crystal data is generated by a liquid-crystal-data generator 24.

The panel driver 31 drives the LCD panel 32 with the output values indicated in the liquid crystal data, and, simultaneously, the backlight driver 34 causes the backlight 33 to glow with the light-source brightness values indicated in the backlight data. This is how the LCD 32 displays the input image.

In the first embodiment, the backlight-data generator 23 and the liquid-crystal-data generator 24 respectively generate the backlight data and the liquid crystal data using not only the input image but also a processed image to be described later.

### Details of Display Controller 20

As illustrated in FIG. 1, in order to perform the above display processing, the display controller 20 includes: an image processor 21; a position detector 22; the backlight-data generator 23; and the liquid-crystal-data generator 24. The backlight-data generator 23 and the liquid-crystal-data generator 24 have the local dimming function, and act as an LCD controller to directly control the display 3 as an LCD.

In the first embodiment, the image processor 21 obtains, from an application run by the display device 1, a level-of-unimportance information item for each of the display items of the application, and, in accordance with the obtained level-of-unimportance information item, decreases brightness of a region for the display item. Specifically, the image processor 21 decreases (e.g., halves) brightness of an unimportant display region of the input image.

As a result, brightness of a light source 331 corresponding to the unimportant display region decreases, and a light source 331 corresponding to a necessary display region glows relatively more brightly than the light source 331 corresponding to the unimportant display region.

Note that, in the display device 1, the storage unit 4 may store, for each of the applications, the level-of-unimportance information item for each of the display items of the application. A group of the level-of-unimportance information items is referred to as a level-of-unimportance information item group. In this case, the display controller 20 obtains a level of unimportance for each display item not from the application run by the display device 1 but from the storage unit 4, and controls brightness of a light source 331 in accordance with the obtained level of unimportance.

When an application is installed in the display device 1, the storage unit 4 may store a level-of-unimportance information item group for the application. Moreover, the user may change a level of unimportance, for each of the display items, in the level-of-unimportance information item group stored in the storage unit 4.

Note that a level of unimportance may be set in three or more stages. In such a case, the image processor 21 may control brightness of an input image in three or more stages in accordance with the level of unimportance. When the level of unimportance is set, for example, in three stages (high, middle, and low), the image processor 21 may (i) keep brightness of an input image from decreasing for a display region displaying a display item having a “low” level of unimportance, (ii) reduce brightness of an input image by half for a display region displaying a display item having a “middle” level of unimportance, and (iii) reduce brightness of an input image by one tenth for a display region displaying a display item having a “high” level of unimportance.

Furthermore, the image processor 21 may obtain information on a level of importance instead of a level of unimportance from an application or the storage unit 4, and control brightness of a light source 331 in accordance with the information on the level of importance. Here, the level of importance indicates how important a display item is. In this case, the image processor 21 decreases brightness of a region, of an input image, corresponding to a display item whose level of importance is a predetermined level or lower. When the storage unit 4 stores the information on the level of importance, a group of the level-of-importance information items is referred to as a level-of-importance information item group.

Note that the image processor 21 may obtain the level-of-unimportance information item group or the level-of-importance information item group not from the storage unit 4 but from a storage device provided outside the display device 1.

Moreover, when the level of unimportance is set in three or more stages, the image processor 21 may change, depending on a status of the display device 1, a threshold of the level of unimportance for determining whether to decrease brightness of an input image. For example, the threshold may be lower when the remaining power of the battery 5 (the remaining battery level) is lower than 50% than when the remaining power of the battery 5 is 50% or higher. In such a case, an application can display three kinds of display items: (i) a display item always presented as a bright region, (ii) a display item presented as a bright region when the remaining battery level is 50% or higher, and as a dark region when the remaining battery level is lower than 50%, and (iii) a display item always presented as a dark region.

Alternatively, when the level of unimportance is high, a ratio for reducing brightness of a display region below that of the display region in an input image may be changed in accordance with, for example, a status of the display device 1. For example, the ratio may be higher when the remaining battery level is lower than 50% than when the remaining battery level is 50% or higher. Specifically, the image processor 21 may reduce the brightness of an unimportant information region in the input image (i) in half when the remaining battery level is 50% or higher, and (ii) in one tenth when the remaining battery level is lower than 50%.

Note that the threshold of a level of unimportance or the remaining battery level for changing the ratio for decreasing the brightness shall not be limited to 50%. Alternatively, the threshold or the remaining battery level may be 30%, or any other value. Furthermore, the image processor 21 may change the threshold or the ratio in accordance with a factor other than the above remaining battery level, such as brightness around the display device 1. Moreover, the image processor 21 may change the threshold or the ratio in three stages or more in accordance with, for example, a status of the display device 1. In addition, if two or more criteria are found for determining a level of unimportance, the level of unimportance may be set in multiple stages on the basis of all the levels of unimportance determined in accordance with different criteria for different regions. The main controller 2 may include a level of unimportance determiner, which determines a level of unimportance as seen above, as a separate functional block from the image processor 21.

The position detector 22 detects position information indicating a position of each display item of an application.

Moreover, the position detector 22 includes a position information holder 221 temporality holding the obtained position information. The position information holder 221 transmits the position information to the image processor 21 when the image processor 21 receives the input image corresponding to the obtained position information. The position information holder 221 can provide the position information to the image processor 21 when the image processor 21 processes the input image. Note that the position information holder 221 is not necessarily essential if (i) the position information can be provided to the image processor 21 in processing the input image, or (ii) the image processor 21 can hold the position information.

The backlight-data generator 23 generates backlight data in accordance with the image processed by the image processor 21 (i.e., a processed image). That is, the backlight-data generator 23 generates the backlight data so that a light source 331 corresponding to an unimportant display region glows less brightly than another light source 331 (i.e., a light source 331 corresponding to a bright region).

The liquid-crystal-data generator 24 generates liquid-crystal data in accordance with the image processed by the image processor 21 (i.e., a processed image), and the backlight data generated by the backlight-data generator 23.

Hence, the backlight-data generator 23 and the liquid-crystal-data generator 24 respectively generate the backlight data and the liquid crystal data in accordance with a position, of a display item having a high level of unimportance, detected by the position detector 22. This is how the display controller 20 can perform the display processing in accordance with a level of unimportance for each of the display items.

### Operation of Display Device

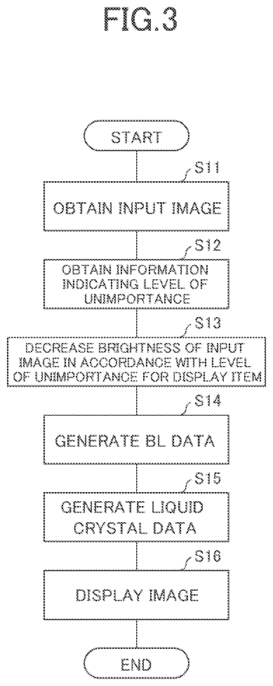

FIG. 3 is a flowchart showing an operation of the display device 1.

In the display device 1, first, the image processor 21 obtains an input image (S11). Next, the image processor 21 obtains information indicating a level of unimportance for a display item (S12). Moreover, the image processor 21 generates a processed image by decreasing brightness of a region included in an input image and corresponding to a display item whose level of unimportance is a predetermined level or higher, in accordance with position information detected by the position detector 22 and indicating a position of each of the display items (S13).

After that, in accordance with the generated processed image, the backlight data generator 23 generates backlight data (S14), and the liquid-crystal-data generator 24 generates liquid crystal data (S15). The display 3 displays an image, using the generated backlight data and liquid crystal data (S16).

Thanks to the above processing flow, a light source 331 corresponding to an unimportant display region glows less brightly than a light source 331 corresponding to a necessary display region. Such a feature makes it possible to reduce power consumption of the display device 1, without deteriorating visibility of the information displayed in the necessary display region.

### Second Embodiment

A second embodiment of the present disclosure will be described below.

In the display device 1 of the first embodiment, the image processor 21 decreases brightness of an input image, displaying a display item, in accordance with the level of unimportance. In contrast, a display device 1A of the second embodiment decreases an upper limit of brightness of a light source 331 corresponding to a display region for a display item, in accordance with a level of unimportance.

As seen in the first embodiment, in the second embodiment, information displayed in an unimportant display region is assumed not to be essential for a user using the display device 1A. On the basis of this assumption, the second embodiment involves setting brightness of the unimportant display region to the upper limit or below to reduce power consumption.

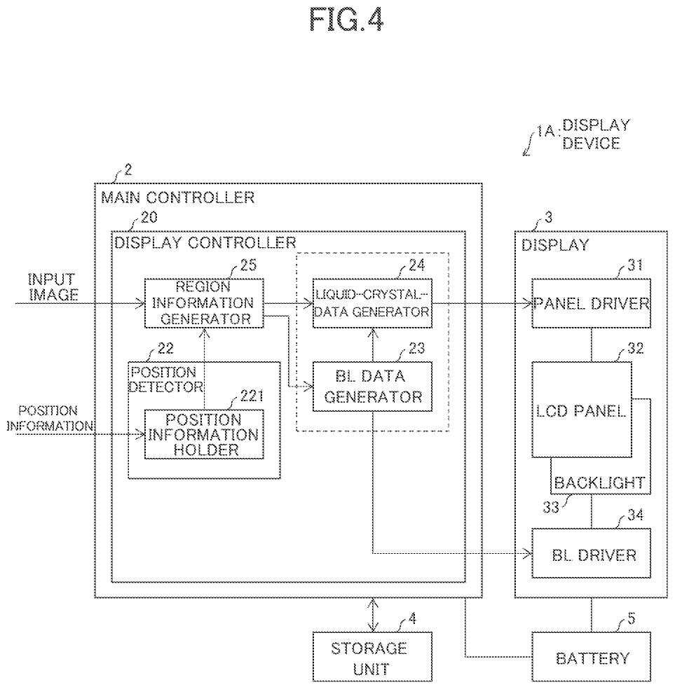

FIG. 4 is a block diagram illustrating a configuration of the display device 1A according to the second embodiment. As illustrated in FIG. 4, the display device 1A includes a region information generator 25 instead of the image processor 21.

The region information generator 25 applies the above the power consumption reduction technique to the unimportant display region, but not to the important display region. A display region to which the power consumption reduction technique is applied is referred to as a low brightness region, and a region to which the power consumption reduction technique is not applied is referred to as a bright region. The low brightness region is a display region to display a part of an input image when the part is displayed with its brightness decreased to be lower than the original brightness of the input image. The low brightness region is the same in advantageous effect as the above dark region in that the part of the input image is displayed consequently with lower brightness than that of the input image.

Specifically, the region information generator 25 determines the bright region and the low brightness region for each display region for a display item detected by the position detector 22, in accordance with a level of unimportance of the display item. The region information generator 25 then outputs to the backlight-data generator 23 an input image and data indicating the bright region and the low brightness region. If the brightness, of a light source 331 corresponding to the low brightness region, determined in accordance with the input image is higher than a predetermined upper limit, the backlight-data generator 23 of the second embodiment generates backlight data in which the brightness is decreased to the predetermined upper limit.

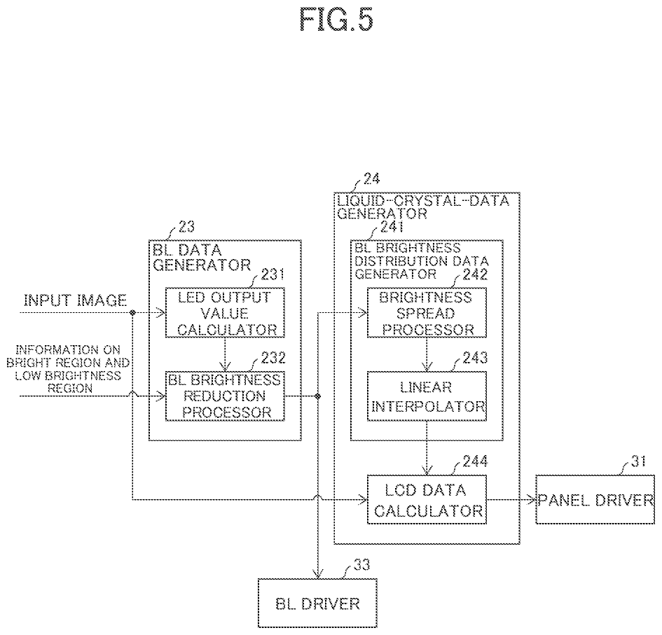

FIG. 5 is a block diagram illustrating specific configurations of the backlight-data generator 23 and the liquid-crystal-data generator 22 according to the second embodiment. As illustrated in FIG. 5, the backlight-data generator 23 includes: an LED output value calculator 231; and a BL brightness reduction processor 232. The liquid-crystal-data generator 24 includes: a BL brightness distribution data generator 241; and an LCD data calculator 244.

The output value calculator 231 calculates output values (brightness) of the light sources 331 for the regions of the backlight 33 in accordance with a brightness value of an input image, and outputs the calculated output values to the BL brightness reduction processor 232. If brightness of a light source 331 corresponding to a kw brightness region is higher than a predetermined upper limit, the BL brightness reduction processor 232 decreases the brightness to the predetermined upper limit. The data indicating the decreased output value of the light source 331 is output as the backlight data to the backlight driver 34 and the liquid-crystal-data generator 24.

Note that the BL brightness reduction processor 232 may use another technique to correct brightness of a light source 331. For example, the BL brightness reduction processor 232 may set, for brightness of a light source 331, the predetermined upper limit and a threshold smaller than the upper limit. The BL brightness reduction processor 232 may then correct brightness, of a light source 331, exceeding the threshold by reducing the brightness within a range from the threshold to the upper limit. Moreover, the BL brightness reduction processor 232 may correct brightness of the light source 331 corresponding to a low brightness region by multiplying the brightness value of the light source 331 by a factor larger than or equal to 0 and smaller than or equal to 1. In such a case, the above factor may be (i) a constant value independent from the brightness of the light source 331, and (ii) a value variable, depending on the brightness of the light source 331, in accordance with a predetermined function (or a value incrementally variable).

The brightness distribution data generator 241 includes: a brightness spread processor 242; and a linear interpolator 243. The brightness spread processor 242 calculates data of brightness distribution among individual light sources 331 in accordance with an output value of an LED and a predetermined brightness point spread function (PSF). The liner interpolator 243 linearly interpolates the data of brightness distribution among the individual light sources 331 to calculate data of brightness distribution throughout the backlight 33. The LCD data calculator 244 calculates liquid crystal data in accordance with the data of brightness distribution throughout the backlight 33 and with an input image. The LCD data calculator 244 outputs the calculated liquid crystal data to the panel driver 31.

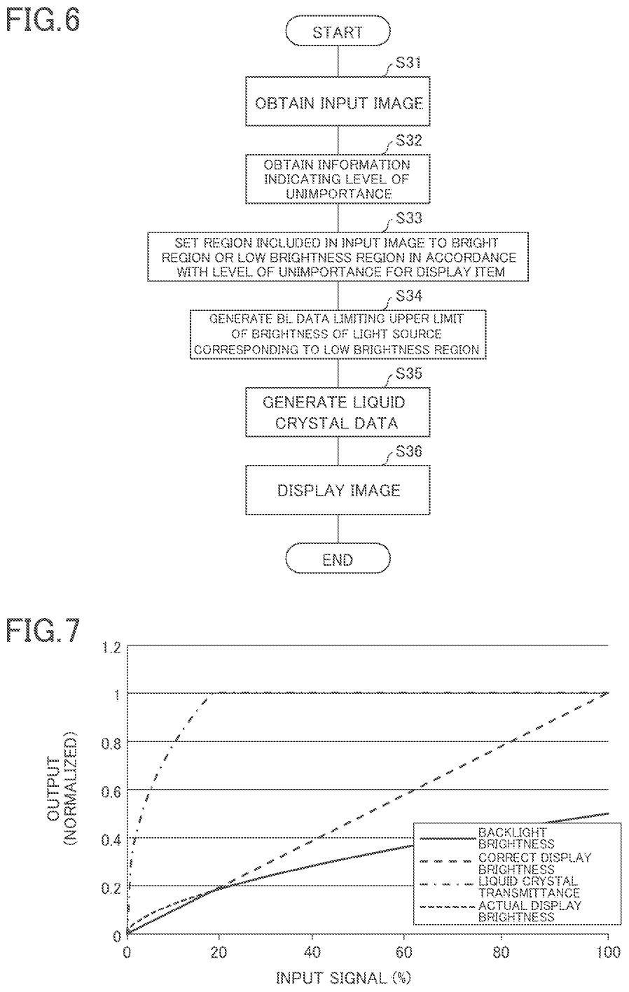

FIG. 6 is a flowchart showing an operation of the display device 1A.

In the display device 1A, first, the region information generator 25 obtains an input image (S31), and then obtains information indicating a level of unimportance for each of the display items (S32). Moreover, the region information generator 25 sets a region included in the input image to a bright region or a low brightness region in accordance with the level of unimportance for each display item (S33). Setting to a bright region in the second embodiment is different from that in the first embodiment in that the former setting involves generating information to identify the region as a bright region.

After that, the backlight data generator 23 generates backlight data in accordance with the input image and information that identifies the low brightness region (S34). Specifically, in the backlight data generator 23, the LED output value calculator 231 calculates output values of the light sources 331, and then the BE brightness reduction processor 232 reduces brightness of a light source 331, corresponding to the low brightness region, to a predetermined upper limit. Moreover, the liquid-crystal-data generator 24 generates liquid crystal data in accordance with the input image and the backlight data (S35). The display 3 displays an image, using the generated backlight data and liquid crystal data (S36).

FIG. 7 is a graph showing backlight brightness with respect to input image brightness, liquid crystal transmittance, and output brightness of the display device 1A.

As illustrated in FIG. 7, the brightness of the backlight 33 in the display device 1A is reduced to half of the normal brightness at most. In the display device 1A, when the input image has a brightness of approximately 18%, the brightness of the backlight 33 is equal to that of the input image. Hence, the liquid crystal transmittance is 1. When the brightness of the input image exceeds approximately 18%, the brightness of an output image falls below that of the input image. In such a case, representation of grayscale brightness depends on backlight brightness. That is why the grayscale brightness is represented poorly. The poor grayscale brightness is otherwise a cause of a poor image. In the second embodiment, however, the information to be displayed in the low brightness region is basically not important for the user. Hence, the information to be displayed in the low brightness region does not have to be displayed using a complex grayscale pattern. Hence, in many cases, this limitation of the brightness does not cause a faulty image. Note that the brightness of 18% is an example determined by a test pattern for evaluating the brightness, and is variable depending on an actual usage environment of the display device 1A. Examples of the usage environment include: a pattern of the input image; an area of a low brightness region; a positional relationship between the low brightness region and a high brightness region; an average brightness of the high brightness region; and a backlight brightness, of the high brightness region, related to the average brightness.

As can be seen, in the display device 1 of the first embodiment, the image processor 21 decreases brightness, of an input image, corresponding to an unimportant display region. As a result, brightness of the backlight 33 corresponding to the unimportant display region decreases, reducing power consumption of the display device 1.

In contrast, in the display device 1A, brightness of a light source 331 corresponding to the unimportant display region has an upper limit, and the backlight data generator 23 causes the light source 331 not to glow more brightly than the upper limit. This is how the display device 1A reduces its power consumption.

In setting the upper limit of the backlight brightness (the brightness of the light source 331), for example, an amount of power to be consumed by the display device 1A may be determined, and the upper limit may be set to correspond to the determined power consumption.

Furthermore, in setting the upper limit of the backlight brightness, for example, an upper limit may be determined for the brightness of a display image whose grayscale representation is desirably maintained. Accordingly, the upper limit of the backlight brightness may be set to correspond to the upper limit of the brightness of the display image. In such a case, for a pixel, of the pixels included in the dark region, whose brightness in the input image is lower than or equal to the above upper limit, the brightness of the display image can be controlled with the liquid crystal transmittance. Hence, the brightness can be controlled precisely.

Note that, in the display devices according to an aspect of the present disclosure, the image processor 21 of the first embodiment and the backlight data generator 23 of the second embodiment may be used in combination. That is, the image processor 21 may decrease the brightness of the input image, and then, the backlight data generator 23 may decrease the backlight brightness in the backlight data.

### Third Embodiment

A third embodiment of the present disclosure will be described below.

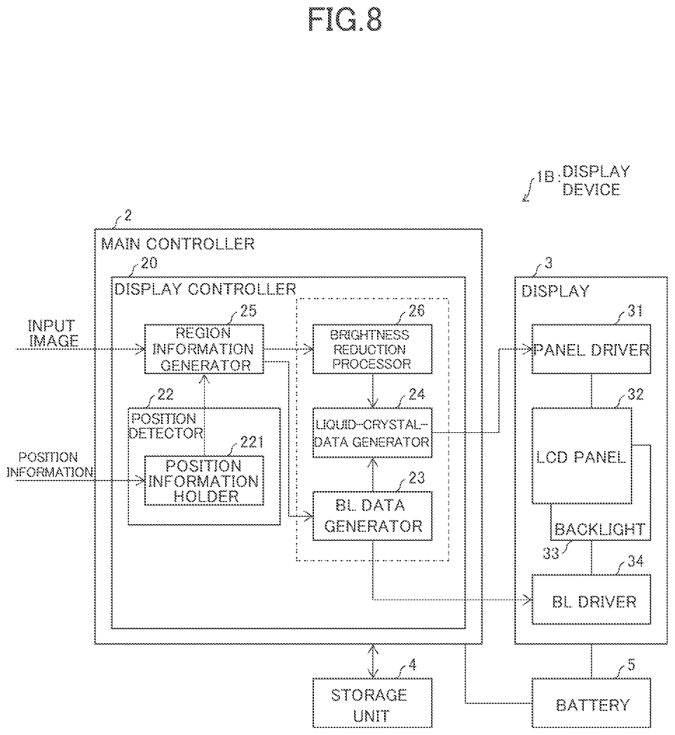

FIG. 8 is a diagram illustrating a configuration of the display device 1B according to the third embodiment. As illustrated in FIG. 8, in addition to the constituent features of the display device 1A, the display device 113 further includes a brightness reduction processor 26.

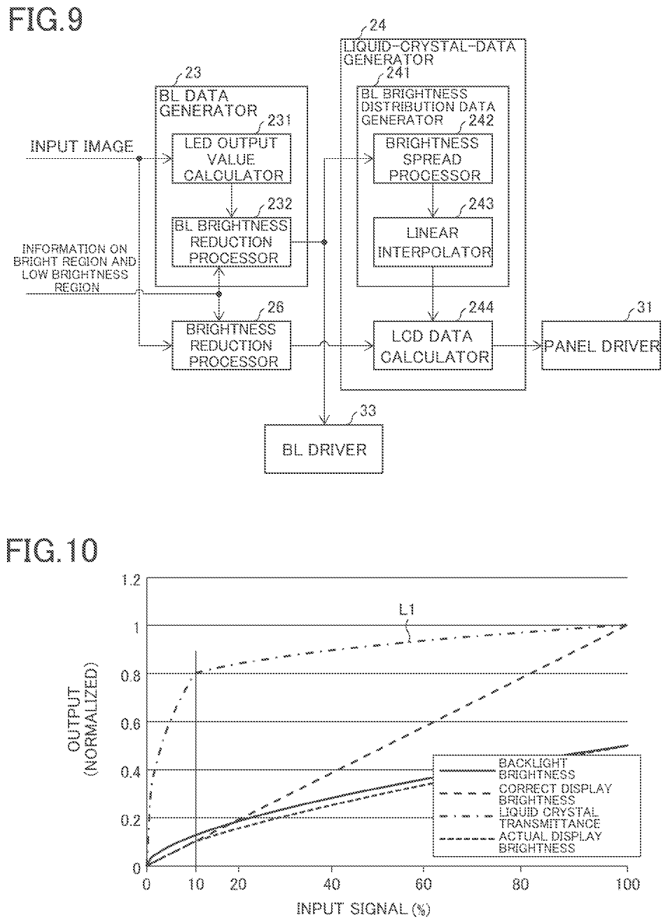

FIG. 9 is a block diagram illustrating configurations of the backlight-data generator 23, the liquid-crystal-data generator 24, and the brightness reducing processor 26 according to the third embodiment. The brightness reduction processor 26 receives an input image, backlight data, and information on a bright region and a low brightness region, and then reduces brightness of some of pixels of the input image to generate a processed image.

As illustrated in FIG. 7, in the case where the brightness of the backlight 33 is decreased to 50%, and the liquid crystal data is generated in accordance with the brightness value of an input image, the input signal strength (e.g., the grayscale value) of the input image is 18% of the maximum strength, and the liquid crystal transmittance is 100%. Hence, when the liquid crystal transmittance reaches 100% in the case where the backlight brightness has the upper limit and the input image is displayed as it is, and the liquid crystal transmittance does not increase depending on the brightness of the pixels of the input image, such a situation is referred to as “the liquid crystal transmittance is saturated.” When the liquid crystal transmittance is saturated, the liquid crystal cannot provide fine grayscale representation. As described before, when the display device 1 is used under normal conditions, the saturation of the liquid crystal transmittance does not cause a serious problem to an image. Depending on a usage of the display device 1, however, it can be highly likely that maintaining the information on the grayscale is preferable.

Hence, for a pixel, of an input image, whose liquid crystal transmittance is higher than or equal to a predetermined value (except for a pixel having the maximum brightness), the brightness reduction processor 26 decreases the brightness of the pixel in a predetermined manner to keep the liquid crystal transmittance from reaching 100% not to saturate the liquid crystal transmittance. The above predetermined value may be, for example, 80%. In the example illustrated in FIG. 7, the input signal strength of the input image is approximately 15%, and the liquid crystal transmittance is 80%.

FIG. 10 is a graph showing backlight brightness with respect to input image brightness, liquid crystal transmittance, and output brightness of the display device 1B. For a pixel, in a low brightness region of the input image, with an input signal strength of 15% or greater, the brightness reduction processor 26 decreases the brightness of the pixel and generates a processed image. A curve L1 in FIG. 10 shows a relationship between the input signal strength and the liquid crystal transmittance of the processed image. That is, the brightness reduction processor 26 decreases the brightness of each pixel in the low brightness region of the input image so that the relationship between the input signal strength and the liquid crystal transmittance of the processed image is represented by the curve L1 (i.e., a predetermined relationship).

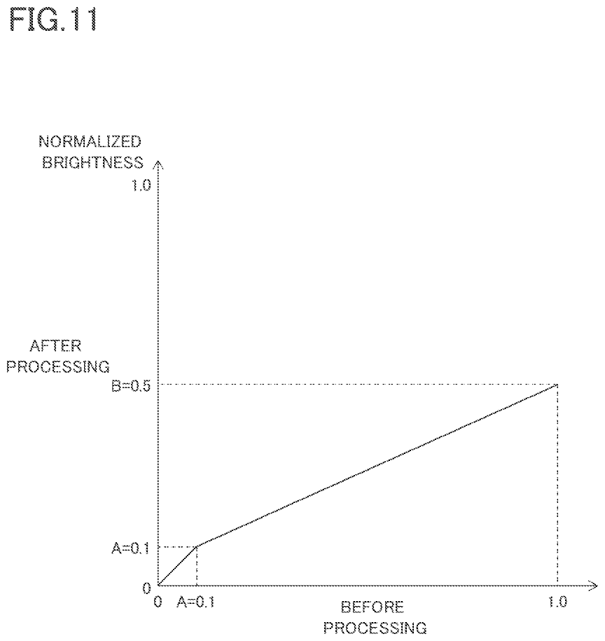

FIG. 11 is a graph showing an example of a relationship between brightness of a pixel before processing and brightness of the pixel after processing performed by the brightness reduction processor 26 included in the display device 1B. For example, the brightness reduction processor 26 decreases brightness of a pixel in a low brightness region of an input image so that the brightness of the pixel before processing and the brightness of the pixel after processing represent the relationship illustrated in the graph of FIG. 11. More specifically, the brightness reduction processor 26 applies: an expression (1) below if the brightness of the pixel before processing is 0 or higher and A or lower; and an expression (2) below if the brightness of the pixel before processing is higher than A and 1 or lower.

y=x . . . (1)

$$\begin{matrix}[ Math . 1 ] & \\ y = \frac{A - B}{A - 1} x + A \frac{B - 1}{A - 1} & ( 2 )\end{matrix}$$

The processing using the expressions (1) and (2) is an example. Other than this linear processing, the brightness reduction processor 26 can perform processing, using a lookup table based on any given preferable curve. Note, however, that, as described before, it is not so important for the brightness reduction processor 26 to precisely perform processing when the display device 1B is used under normal conditions.

In the case where the pixel values of the input image are represented by R, G, and B, the brightness reduction processor 26 may perform the above processing on each of the values of R, G, and B. Moreover, the brightness reduction processor 26 may selectively perform the above processing on any one of R, G, and B, and reduce brightness of the other colors in accordance with a reduction rate of the selected color. Such processing is preferable if a change in shade of color needs to be minimized in the low brightness region. The one color to be selected may be, for example, a predetermined one of the colors (e.g., G), or one of R, G, and B having the largest grayscale. Moreover, the brightness reduction processor 26 may transform the values of R, G, and B into brightness values and chromaticity values, and perform the above processing on the brightness values.

The liquid-crystal-data generator 24 generates liquid crystal data in accordance with a processed image whose brightness of a low brightness region is lower than that of an input image, making it possible to reduce the risk that the liquid transmittance is saturated.

Hence, the display device 1B in the third embodiment allows the liquid crystal to achieve fine grayscale representation even if (i) power consumption is reduced and (ii) the input image is high in brightness.

Note that, in the brightness reduction processor 26, the above predetermined value of the liquid crystal transmittance to determine whether the brightness of the input image is to be decreased shall not be limited to 80%. The predetermined value may be determined as appropriate.

As described before, an object of the display devices according to the present disclosure is to reduce power consumption of the devices by generating a low brightness region, and to maximize visibility even in the low brightness region. Here, the processing performed by the BL brightness reduction processor 232 in FIG. 9 is the only processing directed to reduction in power consumption. The processing performed by the brightness reduction processor 26 contributes only to visibility, not to reduction in power consumption. Meanwhile, as described before, it is not so important to precisely present brightness of grayscale in a low brightness region. That is, the processing by the brightness reduction processor 26 may be directed only to the visibility of the low brightness region.

The brightness reduction processing described with reference to FIG. 11 involves reducing the brightness of the input image on the assumption that the upper limit of the backlight brightness in the low brightness region is 50% (i.e., the brightness of grayscale can be precisely represented if the backlight brightness is 50% or below). If the backlight brightness is lower than 50%, however, an upper limit of an input brightness to be represented by precise grayscale is also naturally low. Such a feature makes it possible to increase visibility without raising a compression ratio of the input brightness.

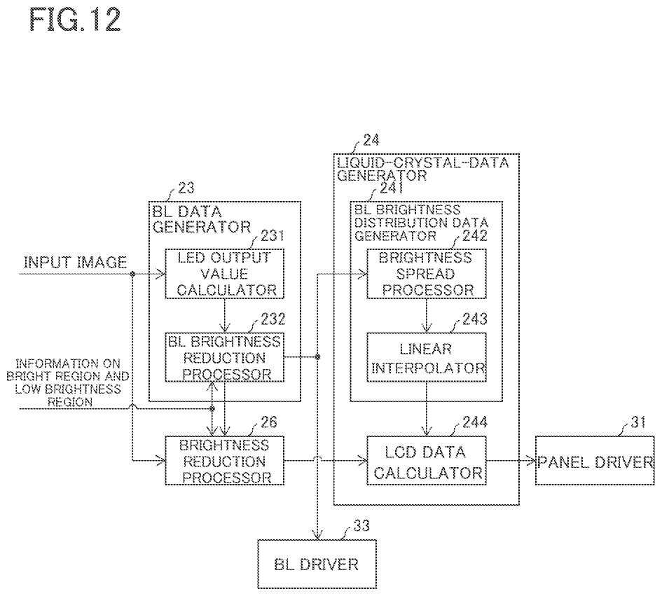

FIG. 12 is a block diagram illustrating other configurations, than those in FIG. 9, of the backlight-data generator 23, the liquid-crystal-data generator 24, and the brightness reduction processor 26 according to the third embodiment. In the configurations illustrated in FIG. 12, BL brightness information on a low brightness region is output from the BL brightness reduction processor 232 to the brightness reduction processor 26. Such a feature makes it possible to optimize presentation of messages while power consumption of the display device 1B is maintained low.

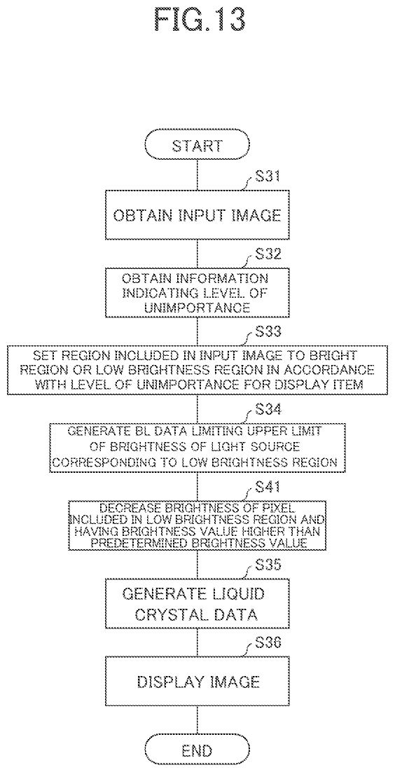

FIG. 13 is a flowchart showing processing performed by the display device 1B according to the third embodiment. Comparing the processing by the display device 1B in the third embodiment with the processing in the third embodiment, the only difference is that, in the former processing, Step S41 is performed between Steps S34 and S35.

In the display device 1B of the third embodiment, backlight data is generated at Step S34. After that, the brightness reduction processor 26 decreases brightness of a pixel included in the pixels of a low brightness region and having a liquid crystal transmittance higher than or equal to a predetermined rate (S41). After that, the liquid-crystal-data generator 24 generates liquid crystal data in accordance with a processed image whose brightness is decreased by the brightness reduction processor 26 (S35).

### Additional Remarks

In the above embodiments, the battery 5 supplies power to the display device. This is because a battery-powered display device is strongly required to reduce power consumption and extend battery life. The technique of this present disclosure may, however, be applied to a display device powered by an external power supply. As a matter of course, such a display device can reduce power consumption, using the techniques of the present disclosure.

The present disclosure shall not be limited to the embodiments described above, and can be modified in various manners within the scope of claims. The technical aspects disclosed in different embodiments are to be appropriately combined together to implement another embodiment. Such an embodiment shall be included within the technical scope of the present disclosure. Moreover, the technical aspects disclosed in each embodiment may be combined to achieve a new technical feature.

### Cross Reference to Related Application

The present application claims priority to Japanese Patent Application No. 2018-114856, filed Jun. 15, 2018, the contents of which are incorporated herein by reference in its entirety.

### Software Implementation

The main controller 2 of the display devices 1, 1A, and 1B may be implemented by logic circuits (hardware) fabricated, for example, in the form of an integrated circuit (an IC chip) and may be implemented by software run by a central processing unit (a CPU).

In the tatter form of implementation, the display devices 1, 1A, and 1B include, among others: a CPU that executes instructions from programs or software by which various functions are implemented; a read-only memory (a ROM) or a like storage device (referred to as a “storage medium”) containing the programs and various data in a computer-readable (or CPU-readable) format; and a random access memory (a RAM) into which the programs are loaded. The computer (or CPU) then retrieves and runs the programs contained in the storage medium, thereby achieving the object of an aspect of the present disclosure. The storage medium may be a “non-transitory, tangible medium” such as a tape, a disc/disk, a card, a semiconductor memory, or programmable logic circuitry. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

### REFERENCE SIGNS LIST

1, 1A, 1B Display Device

3 Display

4 Storage Unit

20 Display Controller (Control device)

102 Touch Panel

331 Light Source

1. A control device of a display device including a display including a plurality of light sources to be independently controlled,
in accordance with levels of unimportance or levels of importance each corresponding to one of display items displayed by one or more applications of the display device, the control device controlling brightness of a light source corresponding to a display region for the one display item, the light source being included in the light sources.

2. The control device according to claim 1, wherein
the control device causes a light source to glow less brightly than another light source, the light source corresponding to a display region displaying a display item the level of unimportance of which is a predetermined level or higher, or the level of importance of which is a predetermined level or lower, the light source and the other light source being included in the light sources, and the display item being included in the display items.

3. The control device according to claim 1, wherein
the control device obtains from one or more of the applications an information item on the level of unimportance or the level of importance for each display item of one or more of the applications, and controls brightness of a light source in accordance with the information item, the light source being included in the light sources.

4. The control device according to claim 1, wherein
the control device decreases brightness of an input image displaying a display item in accordance with the level of unimportance or the level of importance, to decrease brightness of a light source corresponding to a display region for the display item, the light source being included in the light sources, and the display item being included in the display items.

5. The control device according to claim 1, wherein
the control device decreases an upper limit of brightness of a light source corresponding to a display region for a display item, in accordance with the level of unimportance or the level of importance, the light source being included in the light sources, and the display item being included in the display items.

6. A display device comprising the control device according to claim 1.

7. The display device according to claim 6, further comprising
a storage unit configured to store, for each one or more of the applications, a level-of-unimportance information item group indicating the level of unimportance for each display item or a level-of-importance information item group indicating the level of importance for each display item, the display item being displayed by one of more of the applications, wherein
the control device controls brightness of a light source in accordance with the level of unimportance or the level of importance respectively indicated with the level-of-unimportance information item group or the level-of-importance information item group stored in the storage unit, the light source being included in the light sources.

8. A control method for controlling a display device including a display including a plurality of light sources to be independently controlled, the control method comprising
in accordance with levels of unimportance or levels of importance each corresponding to one of display items displayed by one or more applications of the display device, controlling brightness of a light source corresponding to a display region of the one display item, the light source being included in the light sources.
